(19) United States
(12) Patent Application Publication
(10) Pub. No.: US 2010/0261803 A1
(43) Pub. Date: Oct. 14, 2010

(54) PARTICLE STABILISED HIGH INTERNAL PHASE EMULSIONS

(76) Inventors: Alexander Bismarck, Peterborough (DE); Angelika Menner, London (GB); Vivian O. Ikem, Croydon (GB)

Correspondence Address: CHOATE, HALL & STEWART LLP, TWO INTERNATIONAL PLACE, BOSTON, MA, 02110, US

(21) Appl. No.: 12/670,249

(22) PCT Filed: Jul. 24, 2008
(86) PCT No.: PCT/GB08/02537

§ 371 Date: Jun. 24, 2010

(30) Foreign Application Priority Data
Jul. 24, 2007 (GB) 0714436.3
May 30, 2008 (GB) 0809940.0

(51) Int. Cl. C08J 9/28; B32B 1/00

(52) U.S. Cl. 521/76; 428/403; 428/405

(57) ABSTRACT

A particle stabilised high internal phase emulsion comprising an internal phase, a continuous phase and particles comprising a core and a coating, wherein the wettability of the core is modulated by the coating.

The present invention relates to particle stabilised high internal phase emulsions (HIPEs), uses thereof and polymeric foams produced from particle stabilised HIPEs.

An emulsion is a heterogeneous system consisting of two liquids, referred to as phases, which are immiscible or have limited miscibility. In an emulsion, one phase (the internal phase) is dispersed as droplets within the other phase (the continuous phase). Usually, one phase comprises water or an aqueous solution and the other phase comprises an oil, although non-aqueous emulsions comprising two immiscible organic phases can be produced. Emulsions can be classified as oil-in-water emulsions (o/w) in which oil constitutes the internal phase or water-in-oil emulsions (w/o) in which water (or an aqueous solution) constitutes the internal phase. Emulsions containing multiple phases are also possible. Generally, in order to achieve metastable dispersion of one phase within another, the addition of an emulsifier to the emulsion is required. Conventional emulsifiers, such as surfactants, have an amphiphilic molecular structure and stabilise an emulsion by positioning themselves at the phase interface, thereby acting to prevent droplet coalescence. It is also possible to stabilise an emulsion by the addition of a particulate solid. Particle-stabilised emulsions, known as Pickering or Ramsden emulsions, are extremely stable due to the adsorption of particles (which are usually not amphiphilic) at the interface between the continuous and internal phases, providing a barrier to prevent droplet coalescence and phase separation. Stability of an emulsion is determined by the extent to which the particles are wetted by the two immiscible phases, particle size, concentration, and mutual interaction between the particles.

Emulsions have uses in many fields, including the food, pharmaceutical and cosmetics industries. One application is in the preparation of polymer foams. Emulsion templating using high internal phase emulsions (HIPEs) is an effective route to prepare polymer foams known as polyHIPEs. A HIPE is a concentrated emulsion wherein a high proportion of the total volume of the emulsion is made up of the internal phase (typically more than 74%). Typically, polyHIPEs are prepared by a process, which involves providing a w/o RIPE in which the organic continuous phase comprises polymerisable monomers and crosslinkers and initiating polymerisation of the continuous monomer phase. The internal phase droplets act as a template about which polymerisation occurs. After polymerisation, the internal phase is removed, leaving voids in place of the internal phase droplets and thus providing a highly porous foam structure. The pore structure of the polymer foam replicates the internal phase structure of the emulsion at the gel point. PolyHIPEs may also be produced from o/w emulsion or non-aqueous templates.

The morphologies of polyHIPEs can be complex. In addition to the presence of voids, known as cells, there can be windows that interconnect the cells. Thus, the cellular nature of a polyHIPE foam can be varied between closed-cell (without windows) and open-cell. The cellular nature of known polyHIPE foams depends on a number of factors, including the internal phase volume and concentration of stabilising surfactant used. Depending on their properties, polymer foams may be attractive for use in a wide range of applications. Potential applications of polyHIPEs with open porous systems include use as filter membranes, ion exchange resins, supports for solid phase chemistry, matrices for cell culture and scaffolds for tissue engineering. PolyHIPEs with closed cell porous systems are suited to use making sandwich core structures or as structural foams.

The continuous phase of a HIPE is the minority phase in terms of volume and stabilisation against internal phase coalescence and phase inversion is necessary. This is typically achieved by the addition of non-ionic surfactants such as Span 80 (sorbitan monooleate, Sigma, Aldrich, Gillingham, UK) or Hypermers (Uniquema, Wirral UK). Commonly large fractions of expensive surfactant (5-50 wt. % of the organic phase) are required to stabilise HIPEs effectively. The emulsion stability is further increased by suppressing Oswald ripening, using an aqueous electrolyte as the dispersed phase to minimise mutual solubility of the two-phase mixture. Until now, the prevailing view has been that only molecular surfactants are able to stabilise HIPEs with an internal phase volume exceeding 74.5%. Kralchevsky et al presented a thermodynamic model, which predicts particle-stabilised emulsions will phase invert above volume fractions 0.5 but added that experimentally phase inversion is observed at volume fractions of round 0.7 because of kinetic reasons (Kralchevsky et al, Langmuir 2005, 21, 50-63). It has been reported that particle stabilised emulsions are expected to phase invert so that the majority phase is always continuous at volume fractions above between 0.65 and 0.70 (Binks, B. P. et al. Langmuir, 2000. 16(6): 2539-2547). As a result of phase inversion, the minority phase becomes the internal phase and the formation of Pickering-HIPEs was thought to be impossible.

Recently, the preparation of a poly-Pickering foam synthesized by the polymerisation of a medium internal phase emulsion (MIPE) with 60% internal phase volume stabilised solely by carbon nanotubes has been reported (Menner et al., Langmuir 23:2398-2403, 2007). In addition, the preparation of poly-Pickering foams from sedimented MIPE templates (8.43 g water and 10.03 g DVB) stabilised by polymer microgels has recently been reported, in which forced sedimentation was required in order to arrive at particle stabilised HIPEs prior to polymerisation. PMMA-microgel stabilized Pickering w/divinylbenzene (DVB) MIPEs with an internal phase volume under 50% were allowed to settle via gravitation/buoyancy for about 1 hour or were subject to centrifugation to allow separation of excess organic phase from the emulsion underneath, i.e. to create Pickering-HIPEs, prior to polymerization. (Colver et al., Chem Mater 19:1537-1539, 2007).

There is a need in the art for HIPEs that can be prepared without need for the use of a molecular surfactant. Moreover, there is a need in the art for HIPEs that can be prepared in a one step process without the need for forced sedimentation. The inventors have determined that it is possible to produce stable HIPEs, which do not rely on molecular surfactants for stabilisation, but instead are stabilised by functionalised particles. Moreover, the inventors have determined that HIPEs stabilised with functionalised particles can be used to produce polyHIPE foams having favourable properties.

Particles act to stabilise an emulsion by adsorbing at the phase interface, thereby providing a layer that prevents droplet coalescence. The ability of a particle to adsorb at the phase interface is largely determined by the extent to which the particle is wetted by the two phases. Wettability is a measure of the extent of wetting of a solid by a particular liquid (i.e. how a liquid spreads on the surface of the solid). Wettability is quantified by reference to the contact angle (θ) that the solid forms with the liquid, with a low θ indicating high wettability and a high θ indicating low wettability. For an aqueous or non-aqueous liquid, wettability is thus a determinant of hydrophilicity or hydrophobicity, respectively.

In order to stabilise an emulsion, particles lie within the continuous phase, but adsorbed to form a layer at the phase interface. In order to achieve this, the wettability characteristics of the particles must be tailored in respect of the emulsion phases. If the wettability within the continuous or internal phase is too high or the wettability within the internal phase is too low, the particles will remain dispersed within the continuous phase and not adsorb at the phase interface. For example, particles required to stabilise w/o emulsions should be more hydrophobic than particles used to stabilise o/w emulsions. If θ (measured through the aqueous phase) is slightly less than 90° particles will stabilise an o/w emulsion and be held at the interface whereas if θ is slightly greater than 90° w/o emulsions will be stabilised. If the particles are either too hydrophilic (low θ) or too hydrophobic (high θ) particles will tend to remain dispersed within either the aqueous or oil phase, respectively, rather than at the interface and stabilisation will not be successful.

A further improvement in emulsion stability is seen if the particles can interact with each other, leading to formation of a three-dimensional network in the continuous phase surrounding the internal phase droplets.

Therefore, in a first aspect the present invention provides a particle stabilised high internal phase emulsion comprising an internal phase which constitutes more than 75% of the total volume of the emulsion, a continuous phase and particles comprising a core and a coating, wherein the wettability of the core is modulated by the coating.

In a preferred embodiment, the core comprises a hydrophilic material and the coating imparts some hydrophobic character thereto or the core comprises a hydrophobic molecule and the coating imparts some hydrophilic character thereto. Preferably, the core comprises a hydrophilic material. Preferably the hydrophilic material is an inorganic material.

In the context of the present invention, a coating is a layer present on part or the entire surface of a particle. A coating may partially or fully coat the surface of a particle. Preferably, the coating partially coats the surface of a particle such that some of the core may remain exposed. The extent to which a particle is coated is measured in terms of the wt. % of the coating based on the total weight of the coated particle (for example as determined by thermal gravimetric analysis (TGA)).

Preferably, the coating comprises a molecule having a portion capable of interacting with the hydrophilic core and a hydrophobic portion. Preferably, the portion capable of interacting with the hydrophilic core, interacts with the core either by physical adsorption or by chemical attachment to the core surface.

Advantageously, the functionalisation of a particle comprising a core by providing the particle with a coating enables the wettability of the particle to be modified, for example by imparting a hydrophilic core with some hydrophobic character, so as to provide the particles with the appropriate wetting behaviour to stabilise an emulsion. For example, the core (preferably an inorganic core) is naturally hydrophilic and surface treatment enables adjustment of the hydrophilic/hydrophobic properties of the core by imparting some hydrophobic character. This influences the wettability of the particles and ultimately leads to successful stabilisation of HIPEs. Thus, the functionalised particles of the invention have both hydrophobic and hydrophilic character. Particles functionalised in this way act to stabilise the HIPE emulsion so that droplet coalescence and phase inversion do not occur. Thus, the invention enables the stabilisation of emulsions with higher internal phase volumes than was previously thought possible without the use of high proportions of molecular surfactant. Stabilisation of emulsions having internal phase volumes of up to 92% has been successfully demonstrated.

The particles may be provided as micron-sized particles, nanoparticles, particle aggregates (preferably nanoparticle aggregates) or any combination thereof.

In a preferred embodiment, the particles have an average diameter of up to 50 μm, for example provided by the aggregation of nanoparticles during the modification process. Preferably, the particles have an average diameter up to 500 nm. More preferably, the particles are nanoparticles having an average diameter of from 15 nm to 100 nm, preferably 15 nm to 50 nm, more preferably 15 nm to 30 nm.

Preferably, the average diameter of the individual stabilising particles or particle aggregates is from 15 nm to 50 μm.

In a preferred embodiment, the internal phase of the emulsion constitutes up to (and including) 92 vol %, of the total volume of the emulsion. In certain embodiments, the internal phase volume is 76-92 vol %, 76-90 vol %, 80-90 vol % or 80-85 vol %.

In a preferred embodiment, the emulsion is an o/w emulsion or a w/o emulsion. Preferably, the emulsion is a w/o emulsion. Thus, preferably water (or an aqueous solution) constitutes the internal phase and oil constitutes the continuous phase, which can also be referred to as the organic phase.

In a preferred embodiment, the inorganic core of the particles comprises a metal oxide (for example titania, a zinc oxide, a magnesium oxide, an iron oxide or an aluminium oxide) or silica (SiO₂).

Preferably, the coating comprises at least one type of amphiphile. Untreated metal oxide or silica particles are very hydrophilic and do not successfully stabilise HIPEs. The hydrophilic portion of the amphiphile is adsorbed onto the metal oxide or silica core and the hydrophobic portion of the amphiphile forms a partial coating on the surface of the particles. The particles thus comprise a hydrophilic metal oxide or silica core and a partial coating comprising the amphiphile, wherein the coating gives the surface of the particles some hydrophobic character. When a hydrophilic particle is functionalised by introducing some hydrophobic character, its wetting characteristics can be altered such that stabilisation can successfully be achieved.

Preferably, the metal oxide is titania (TiO₂). Titania particles are naturally hydrophilic meaning they cannot stabilise w/o HIPEs without functionalisation. Functionalisation by providing a coating introduces hydrophobic character, influencing the wettability of the particles and allowing their successful use to stabilise HIPEs.

Preferably, the amphiphile is a saturated or unsaturated fatty acid, preferably comprising between 16 and 20 carbon atoms. Preferably, the fatty acid is an unsaturated fatty acid. More preferably, the fatty acid is oleic acid. Unsaturated fatty acids comprise at least one polymerisable double bond. Advantageously, when a RIPE is polymerised to form a polyHIPE foam, the presence of a polymerisable double bond allows for the covalent incorporation of the functionalised particles into the polymer. This is advantageous because it increases strength and stability of the polymer network.

In an alternative embodiment, the coating comprises an acryl-functionalised silane. Preferably, the acryl-functionalised silane is of formula (I):

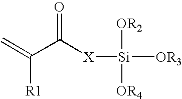

wherein R1 is hydrogen or C₁₋₆ alkyl (preferably methyl);
each of R₂, R₃ and R₄ is independently C₁₋₆ alkyl, preferably methyl; and
X is an alkyl chain optionally containing one or more —O-insertions.

Preferably, X is —O(CH₂)ₙ— wherein n is an integer from 1 to 6, preferably 3.

Preferably, the silane is methacryloxypropyltrimethoxysilane (MPS).

Where the coating comprises an acryl-functionalised silane, the silane moiety is capable of reacting with the surface hydroxyl functional groups of the hydrophilic metal oxide or silica core and the acryl moiety imparts the particle with some hydrophilic character. The silane moiety forms covalent bonds of the type M(or Si)—O—Si—R) with the silica network or metal oxide core.

Moreover, the acryl moiety can be polymerised. Thus, advantageously, when a HIPE is polymerised to form a polyHIPE foam, the functionalised particles can be incorporated into the polymer, increasing strength and stability of the polymer network.

Preferably, the amphiphile constitutes 2 to 5 wt. % of the particle, more preferably 2 to 4 wt. %, even more preferably 2 to 3 wt %, most preferably, 2.5 wt. %. The level of hydrophobicity of the particle can be tailored by the amount of amphiphile incorporated onto the particle.

Where the coating comprises an acryl-functionalised silane, the silane constitutes 2 to 5 wt % of the particle, preferably 2 to 4 wt %, more preferably 3 wt %. The level of hydrophobicity of the particle can be tailored by the amount of silane incorporated onto the particle.

In a preferred embodiment, particles are present in the emulsion at a weighting from 0.5 to 4 wt %, 0.5 to 3 wt. % (preferably 1 wt. %) based on the continuous phase. Advantageously, effective stabilisation can be achieved using low particle weightings in an emulsion.

In certain embodiments, the particles can be used not only to stabilise the emulsion but also to provide reinforcement or to optimise pore size of a RIPE foam produced from the emulsion. In these embodiments a higher wt % of particles may be present, for example up to 20 wt %.

The emulsion may comprise a uniform population of particles or a non-uniform population in which the hydrophobicity/hydrophilicity characteristics of the population of particles within the emulsion show some variation. This may be because particles having different core and coating materials are present or because a population of particles having the same core and coating has some variation in composition. The presence of variation in the particle characteristics, when the emulsion is polymerised to form a polyHIPE foam, can lead to multiple structures within the porous foam, for example polymer balls with pores. Such multiple structures are of interest for applications where the foam is intended to provide controlled delivery of a substance.

In a preferred embodiment, the emulsion is free of molecular emulsifier (e.g. surfactant). Thus, the emulsion contains no entity that acts as an emulsifier other than the particles.

In an alternative embodiment, the emulsion comprises a small amount of surfactant, preferably 1 wt % or less, more preferably 0.5 wt % or less (based on the continuous phase). The inclusion of a small amount of surfactant is another way in which multiple structures in the resulting polyHIPE foam can be produced.

Preferably, the continuous phase comprises at least one type of polymerisable monomer (such as styrene). Preferably, the continuous phase also comprises at least one type of crosslinker (such as divinylbenzene or polyethylene glycol dimethacrylate). An emulsion in which the continuous phase comprises polymerisable monomers and crosslinkers is of particular use in the preparation of porous polymer foams.

In a preferred embodiment, the crosslinker is a flexible crosslinker such as polyethylene glycol dimethacrylate (PEGDMA). PolyHIPEs can be brittle and have low shear resistance. The use of a flexible crosslinker reduces this brittleness increases shear resistance, thus improving the mechanical properties of the resulting polymer foam.

Preferably, the continuous phase additionally comprises a radical initiator such as azobisisobutyronitrile (AIBN), 2,2′-azodi(2-methylbutyronitrile) or 2,2-di(4,4-di(tertbutylperoxy)cyclohexyl)propane. Alternatively, the internal phase comprises a radical initiator such as potassium persulfate.

Preferably, the internal phase comprises an electrolyte. Use of an electrolyte as the internal phase increases emulsion stability by suppressing Oswald ripening. The internal phase preferably comprises a salt, an acid or a base. Charged particles dispersed in the internal (preferably aqueous) phase have been shown to have the same effect as an electrolyte in acting to suppress Oswald ripening.

In a preferred embodiment, the emulsion additionally comprises non-functionalised particles, for example carbon particles. Preferably, these particles have a maximum dimension of 2-5 μm. Preferably, the particles are provided at a weighting of ≦5 wt %, preferably 3-5 wt %, more preferably 5 wt % with reference to the continuous phase.

In a second aspect, the present invention provides a particle stabilised high internal phase emulsion comprising an internal phase, a continuous phase and a population of particles comprising a core comprising a metal oxide (for example titania) and a coating comprising a fatty acid, wherein the wettability of the core is modulated by the coating. Preferably the internal phase constitutes at least 74% of the total volume of the emulsion, more preferably at least 75 vol %. Preferably, the population of particles comprises particles comprising a metal oxide core and a fatty acid coating, wherein the particles are as defined in respect of the first aspect of the invention.

In a third aspect, the present invention provides a particle stabilised high internal phase emulsion comprising an internal phase, a continuous phase and a population of particles comprising a core comprising silica and a coating comprising an acryl-functionalised silane, wherein the wettability of the core is modulated by the coating. Preferably the internal phase constitutes at least 74% of the total volume of the emulsion, more preferably at least 75 vol %. Preferably, the population of particles comprises particles comprising a silica core and a coating comprising an acryl-functionalised silane, wherein the particles are as defined in respect of the first aspect of the invention.

The preferable features of a high internal phase emulsion according to the first aspect of the invention apply to a high internal phase emulsion of the second and third aspects of the invention. These preferable features include the internal phase volumes, particle sizes, presence or absence of molecular emulsifier, electrolyte, radical initiator and/or non-functionalised particles and composition of the continuous phase as defined in respect of the first aspect of the invention.

In a fourth aspect, the present invention provides a method of producing a stabilised HIPE comprising an internal phase and a continuous phase, wherein the internal phase constitutes more than 75% of the total volume of the emulsion, the method comprising suspending a population of particles comprising a core and a coating, wherein the wettability of the core is modulated by the coating, within the continuous phase, mixing the internal phase with the continuous phase and agitating the mixture to produce a stabilised emulsion.

The method of the fourth aspect allows the preparation of a HIPE in a process that does not require sedimentation to achieve a high internal phase volume (of more than 75% of the total volume of the emulsion). Although some sedimentation due to gravity may be observed following agitation of the continuous phase/internal phase mixture, this sedimentation is limited to that which occurs immediately after agitation until the sedimented emulsion reaches a stable internal to continuous phase volume ratio. It is not necessary to leave the emulsion to settle or to force sedimentation, for example by centrifugation, in order to achieve a stabilised HIPE.

Moreover, advantageously the agitation to form the emulsion can be by stirring, a low energy emulsification method. This contrasts to high energy shearing emulsification methods which are often used in the art.

The preferable features of a high internal phase emulsion according to the first aspect of the invention apply to a high internal phase emulsion produced in the method of the fourth aspect of the invention.

In a fifth aspect, the present invention provides a porous polymer foam produced by polymerisation of the continuous phase of a stabilised high internal phase emulsion comprising an internal phase, a continuous phase comprising at least one type of polymerisable monomer and particles comprising a core and a coating, wherein the wettability of the core is modulated by the coating. The foam comprises a three-dimensional polymeric network defining pores, with particles located at the interface of the polymeric network and pores.

In a preferred embodiment, the porosity of the foam is at least 74 vol %, preferably at least 75 vol %, more preferably between 78 vol % and 92 vol %.

In a preferred embodiment, the porous foam is produced by polymerisation of an emulsion according to the first, second or third aspects of the invention. Therefore, the preferable features of a high internal phase emulsion according to the first, second or third aspects of the invention apply to a high internal phase emulsion used to produce a porous polymer foam of the fifth aspect of the invention. Thus, for example, the preferred features of a particle defined in respect of the first, second or third aspects of the invention apply to the particles contained within the porous polymer foam.

The addition of functionalised particles not only acts to stabilise Pickering-HIPE emulsion templates, but may also be used to reinforce the resulting polymer foam and/or to functionalise the foam to introduce other benefits to the resulting nanocomposite polymer foams. These benefits include, for example if TiO₂ is used, catalytic activity, UV-absorption or enhanced surface roughness, which may lead to a variety of applications in the future. A foam according to the invention may be of use as a sandwich core or as a structural foam, particularly because foams of the invention can easily be moulded.

In a sixth aspect, the present invention provides a method of producing a porous polymer foam wherein the method comprises providing a high internal phase emulsion as defined in the first, second or third aspect of the invention or as produced by the fourth aspect of the invention, wherein the continuous phase comprises a polymerisable monomer and wherein the continuous phase and/or the internal phase comprises an initiator, and initiating polymerisation of the continuous phase. Preferably, the continuous phase comprises an initiator.

Preferably, initiation of polymerisation is achieved by heating the high internal phase emulsion. Preferably, following polymerisation, the internal phase is removed by drying, by subjecting the foam to heat and/or vacuum.

The method of the sixth aspect allows the preparation of a HIPE and its' subsequent polymerisation to produce a polymer foam in a process that does not require forced sedimentation to achieve a high internal phase volume prior to polymerisation. Advantageously, it is not necessary to allow the emulsion to stand to allow sedimentation to occur or even to subject the emulsion to centrifugation in order to force sedimentation to occur in order to increase the internal phase volume of the emulsion prior to initiating polymerisation. Although some sedimentation due to gravity may be observed in this method, this sedimentation is limited to that which occurs during production of the emulsion and during the early stages of the polymerisation (i.e. before reaching the gel point of the polymerisation). It is not necessary to leave the emulsion to settle or to force sedimentation, for example by centrifugation, in order to achieve a stabilised HIPE prior to polymerisation. Preferably, when a HIPE emulsion is prepared and polymerised according to the invention, any sedimentation that occurs will lead to expulsion of no more than 30% of the internal phase. If an emulsion sediments during polymerization, a layer of non-porous polymer will be produced on top of the polyHIPE foam. In some cases the polymer film may be useful as a protective layer. However, generally the non-porous polymer is cut off before the polyHIPE is used, with the non-porous polymer layer being wasted material. In view of this, the provision of emulsions in which sedimentation is minimized is advantageous.

In a seventh aspect, the present invention provides a particle comprising an inorganic core and a coating, wherein the wettability of the inorganic core is modulated by the coating and wherein the coating comprises a fatty acid. Preferably, the inorganic core comprises silica or a metal oxide, more preferably titania. Preferably, the fatty acid is an unsaturated fatty acid, preferably oleic acid.

Preferred features of the particles defined above in respect of the first aspect of the invention apply equally to the particles of the seventh aspect of the invention.

In an eighth aspect, the present invention provides an emulsion stabilised by, preferably solely by, a population of particles according to the seventh aspect of the invention. Preferably, the emulsion is a high internal phase emulsion with 74% or higher internal phase, preferably higher than 75% internal phase.

Preferred features of the emulsion and particles defined above in respect of the first, second and third aspects of the invention apply equally to the eighth aspect of the invention.

In a ninth aspect, the present invention provides a method of producing a stabilised HIPE comprising an internal phase and a continuous phase, the method comprising suspending particles according to the seventh aspect of the invention within the continuous phase, mixing the internal phase with the continuous phase and agitating the mixture to produce a stabilised emulsion. Preferably, the emulsion is a high internal phase emulsion with 74% or higher internal phase, preferably higher than 75% internal phase.

Preferred features of the emulsion and particles defined above in respect of the first, second and third aspects of the invention apply equally to the ninth aspect of the invention.

In a tenth aspect, the present invention provides a porous polymer foam produced by polymerisation of the continuous phase of an emulsion stabilised by particles according to the seventh aspect of the invention. Preferably, the emulsion is a high internal phase emulsion with 74% or higher internal phase, preferably higher than 75% internal phase. The foam comprises a three-dimensional polymeric network defining pores, with particles located at the interface of the polymeric network and pores. In a preferred embodiment, the porosity of the foam is at least 74%, preferably at least 76%, more preferably between 78% and 92% (for example, between 78% and 88%).

Preferred features of the emulsion and particles defined above in respect of the first, second and third aspects of the invention apply equally to the tenth aspect of the invention.

In a eleventh aspect, the present invention provides a method of producing a porous polymer foam comprising providing an emulsion as defined in the sixth aspect of the invention or as produced by the seventh aspect of the invention, wherein the continuous phase comprises a polymerisable monomer and wherein the continuous phase and/or the internal phase comprises an initiator, and initiating polymerisation of the continuous phase. Preferably, the continuous phase comprises an initiator.

Preferred features of the method of the sixth aspect of the invention apply to the eleventh aspect.

It will be appreciated that preferred features of the invention apply to all other aspects mutatis mutandis.

The invention may be put into practice in various ways and a number of specific embodiments will be described by way of example to illustrate the invention with reference to the accompanying drawings in which:

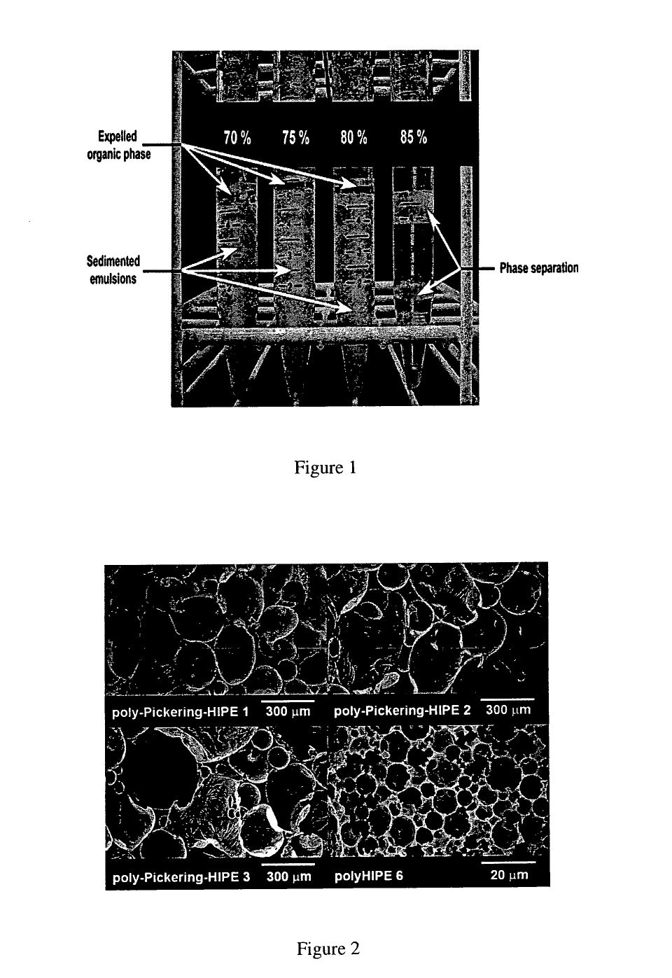

FIG. 1 shows a photograph showing sedimentation of 70%, 75% and 80% emulsions and an 85% phase separated emulsion prepared with functionalized TNP containing 2.5 wt. % oleic acid (emulsions 1-4) 24 h after emulsion preparation.

FIG. 2 shows SEM images of polymer foams produced from emulsions 1-3 and 6.

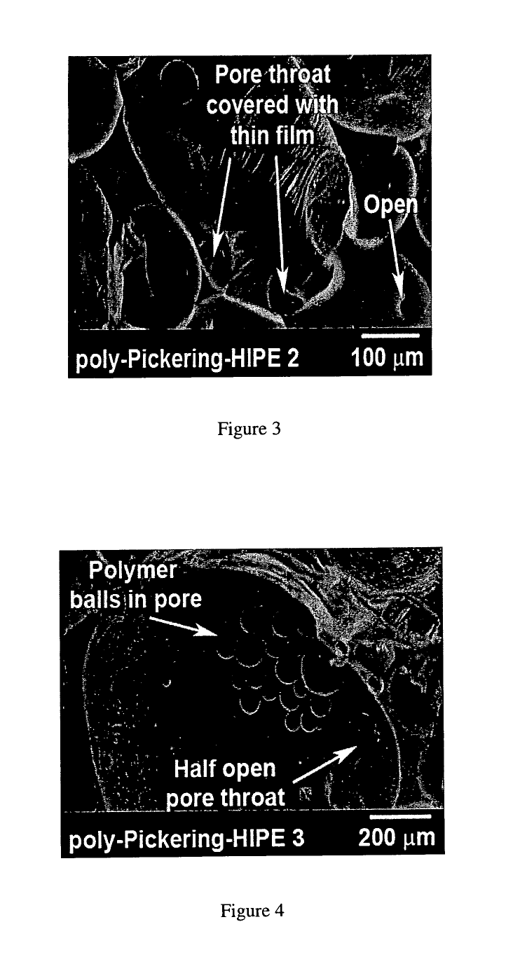

FIG. 3 shows a SEM image showing open and closed pore throats within a polymer foam produced from emulsion 2.

FIG. 4 shows a SEM image of a polymer foam produced from emulsion 3, in which polymer balls can be seen within the pore structure. A half-open pore throat can also be seen. This structure is formed due to the presence of some particles which were less hydrophobic than the rest of the particles. These less hydrophobic particles form o/w emulsions within the droplets of the w/o emulsions, giving rise to multiple emulsions, leading to multiple structures.

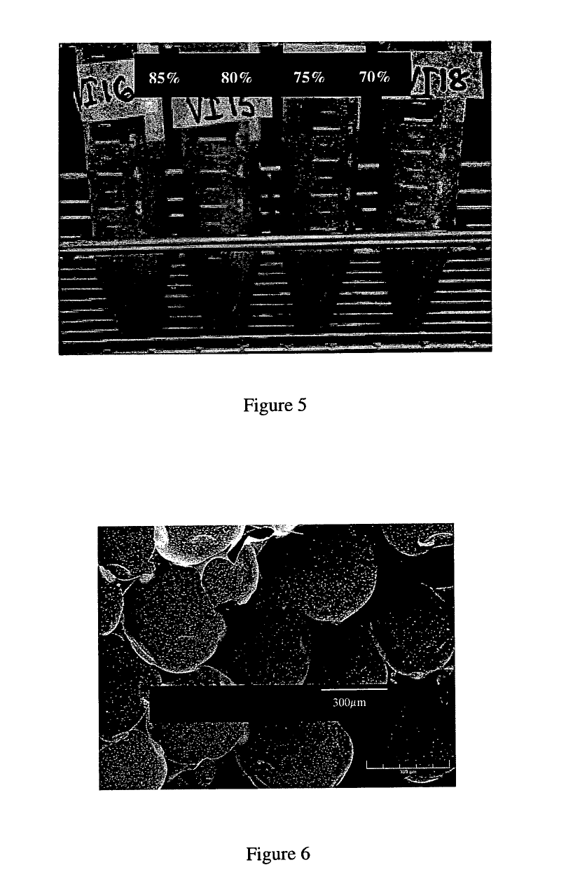

FIG. 5 shows a photograph of emulsions prepared with titania nanoparticles coated with 4 wt % oleic acid, with internal phase volumes of 70, 75, 80 and 85% 24 h after emulsion preparation.

FIG. 6 shows a SEM image of a tough polyPickeringHIPE made from a Pickering RIPE template containing 80 vol. % aqueous phase and 20 vol. % organic phase comprising a 50:50 mixture of styrene and PEGDMA.

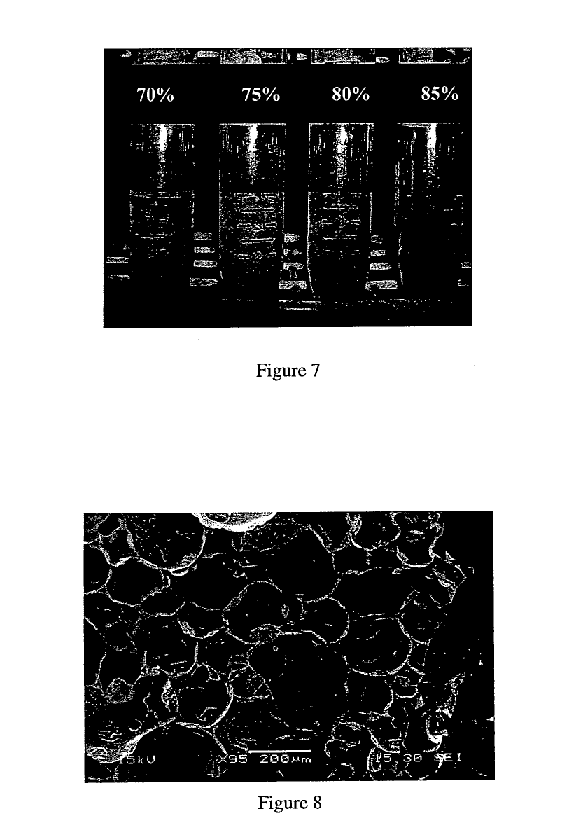

FIG. 7 shows a photograph showing 70%, 75%, 80% and 85% internal phase emulsions stabilised by 1 wt % functionalised silica particles after 24 hours. Only the 70% emulsion showed sedimentation.

FIG. 8 shows a SEM image of a HIPE foam, synthesised from an emulsion template having 90% internal phase volume and stabilised by 5 wt.-% of the functionalised silica particles.

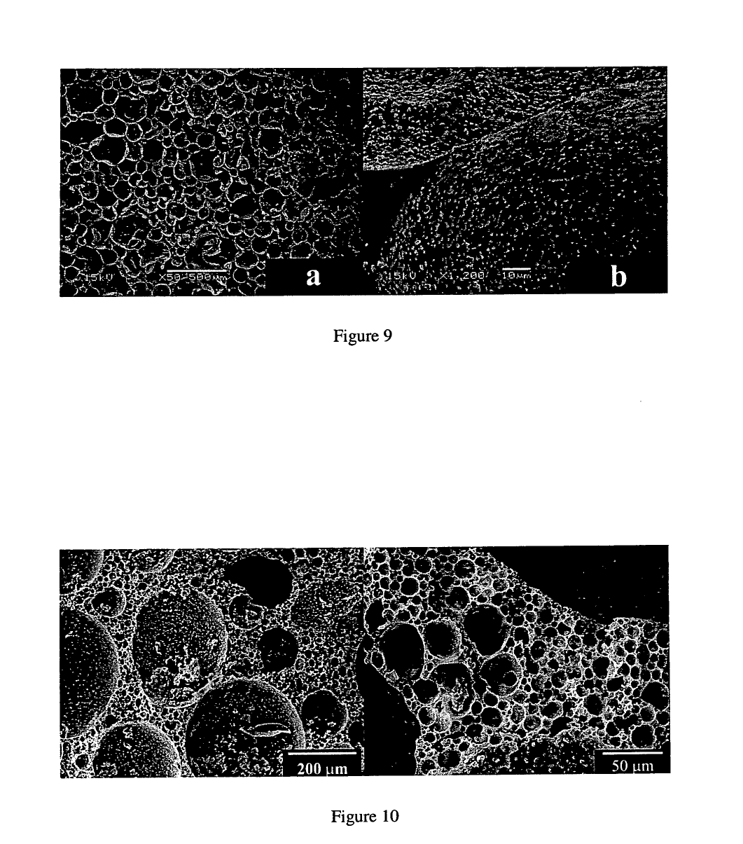

FIG. 9 shows SEM images of a poly-Pickering-foam synthesized from an emulsion template having 80 vol.-% internal phase and stabilised by 3 wt.-% of oleic acid functionalised titania particles. Furthermore, the emulsion template contained 5 wt.-% carbon particles, which were added to the organic phase. a) Low magnification image showing the characteristic pore structure of poly-Pickering-foams and b) High magnification image showing a mixture of titania and carbon particles in the pores.

FIG. 10 shows SEM images of a polyHIPE synthesised from an 80 vol % HIPE stabilised by 1 wt % functionalised titania particles and 0.5 wt % Hypermer B246sf at low and higher magnifications.

The meanings of terms used herein are explained below, and the invention will now be further illustrated with reference to one or more of the following non-limiting examples.

As used herein, a ‘monomer’ is an organic molecule that is capable of undergoing polymerization. Monomers known in the art include styrene, acrylates, methacrylates, pyrollidones and acrylamides. Monomers may also be “bio-based monomers” such as epoxidized acrylated soy bean oil, functionalized polylactic acid resin or a polymensable oil such as cashew nut oil, palm oil or coconut oil.

As used herein, a ‘cross-linker’ is a compound capable of forming links with two or more polymer chains, for example polyethylene glycol dimethacrylate or divinylbenzene.

### EXAMPLE 1

### Preparation of Functionalised Titania Nanoparticles

Titania nanoparticles (P25; 20 nm in diameter) were obtained from DEGUSSA AG (Frankfurt, Germany). Titania nanoparticles (TNP) are very hydrophilic. To reduce their hydrophilicity, the particles were treated with oleic acid. 1 g of TNP was suspended in a 1:2 molar mixture of chloroform and oleic acid. The suspension was stirred for 3 h, after which methanol was added to precipitate the nanoparticles before centrifugation. Excess oleic acid was then removed during a purification step in which the nanoparticles were re-suspended in freshly distilled chloroform using an ultrasonic nozzle. Methanol was added to precipitate the nanoparticles before centrifugation. This process was repeated five times after which the purified TNP were dried under vacuum at 120° C. for 24 h. The oleic acid content of the TNP was 2.5 wt. %, as determined by thermogravimetric analysis (TGA) in air.

### EXAMPLE 2

### Use of Functionalised Nanoparticles to Stabilise Pickering Emulsions and Formation of Polymer Foams Therefrom

The nanoparticles produced in Example 1 were used to stabilise a Pickering-medium internal phase emulsion (MIPE) (emulsion 1) and Pickering-HIPEs with increasing internal phase volumes (emulsions 2-4). Emulsions 1-4 had internal aqueous phase volumes of 70%, 75%, 80% and 85% respectively. The continuous phases of all mixtures consisted of 1 wt. % of nanoparticles suspended in a 50:50 mixture of styrene and DVB (by volume) using a high speed stirrer at 15000 rpm for a period of 15 min. The initiator, 1 mol % azobisisobutyronitrile (AIBN), was then introduced with stirring at 400 rpm, followed by the gradual addition of the aqueous phase, consisting of 0.03 mol/l CaCl₂.2H₂O. Finally, the stirring rate was increased to 2000 rpm in order to obtain stable emulsions after which approximately 5 ml of each emulsion was poured into smaller falcon tubes to study the emulsions. Pickering-MIPE 1 and Pickering-HIPEs 2-3 were w/o emulsions. Some sedimentation was observed immediately after preparation. The volume of the organic continuous phase expelled from the sedimented emulsions 1-3 was determined and the new internal phase volume calculated to be 79%, 81% and 85%, respectively. It was noted that the volume of separated organic phase decreased with increasing internal phase volume. Immediate phase separation was observed for emulsion 4. These results suggest that for emulsions stabilised by functionalised TNPs having an oleic acid content of 2.5 wt. %, the emulsion stability increases with increasing internal phase volume, but that for the above described emulsion system stabilised with 1 wt. % of 2.5 wt. % oleic acid functionalised titania nanoparticles an upper limit for initial internal phase volume exists between 80% and 85%. However, it will be appreciated that this upper limit will vary dependent on the particular emulsion system and functionalised nanoparticles used for stabilisation.

The results above demonstrate that it has been possible to stabilise an emulsion having an internal phase with a volume fraction of at least up to 0.80 using only 1 wt. % of 2.5 wt. % oleic acid functionalised titania nanoparticles.

The oleic acid adsorbed to the surface of the titania cannot be directly responsible, in a molecular sense, for this stabilisation. Firstly, the total oleic acid content calculated in terms of the continuous phase is extremely low ˜0.03 wt. % and secondly, attempts to stabilise HIPEs solely with 0.2 wt. % oleic acid failed. Oleic acid bound to TiO₂ does not act as a molecular surfactant, since its polar head group is bound tightly to the surface but it turns the titania more hydrophobic, by attaching long alkyl chains.

For comparison, a ‘traditional’ surfactant-stabilised HIPE 6 with an internal phase volume of 80% was made using similar conditions to Pickering-HIPEs 3 and 5 but using 20 vol.-% of the non-ionic polymeric surfactant Hypermer 2296.

Each of the emulsion templates (emulsions 1-3, 6) were transferred into Flacon tubes, which were sealed and allowed to polymerise in an oven at 70° C. for 24 h. The resulting polymer monoliths were removed from the tubes, dried in an oven at 110° C. for 24 h and then transferred to a vacuum oven for further drying at 110° C. for 24 h.

The polymerisation of the continuous phase of Pickering emulsions 1-3 resulted in porous but brittle polymer monoliths. This brittleness is not, however, attributable to the use of particulate stabilisers and the use of particles as an emulsifier does not influence the brittleness of the foams. Similar brittleness is seen with surfactant stabilised systems, when DVB is used as a crosslinker. The matrix densities of polymer foams 1-3 were identical, within error, at 1.12±0.01 g/cm³. However, the average foam densities were 0.234±0.001 g/cm³ (1), 0.229±0.001 g/cm³ (2), 0.206±0.001 g/cm³ (3), with porosities of 79±1% (1), 80±1% (2), and 82±1% (3). The experimentally determined porosities are similar to the final internal phase volume of the sedimented emulsion templates although for poly-Pickering HIPEs 2 and 3, they are slightly lower because of the slow sedimentation process. It is thought that this difference is a result of the completion of the polymerization before total sedimentation occurred. In the case of the polyHIPE prepared from the traditional RIPE template (6) with 80% internal phase volume the same as Pickering-HIPE 3, the foam density was (0.144±0.003 g/cm³) and the porosity was (87±1%). However, unlike poly-Pickering-HIPE 3, this high porosity can be attributed to the loss of molecular surfactant during washing/drying.

Turning to the microstructure, SEM studies show that a polymer foam produced from surfactant stabilised emulsion 6 (see FIG. 2) has a typical open porous network structure. Pores of 6-12 μm in diameter are interconnected via pore throats of about 3±1 μm. In contrast to this, polymer foams generated from functionalised nanoparticle stabilised emulsions 1-3 have much larger closed cell pores. The pore size was generally in the range of 100-400 μm for all polyHIPEs, although a few bigger pores (600-700 μm) and smaller pores (20-100 μm) were observed. The smaller pores were evident in the pore walls (See FIG. 2).

Another important difference between the foams made from Pickering emulsion and those made from surfactant stabilised emulsions is the degree of pore interconnectivity. Although the pores of the poly-Pickering-foams 1-3 are mostly closed, areas in the pore walls covered by an extremely thin polymer layer are visible.

These areas represent the contact faces between closest neighbouring droplets in the emulsion template where usually pore throats would form within a foam formed from surfactant stabilised emulsions. The pore throat formation in traditional polymer foams is supported by large amounts of surfactants. It is suggested that this in surfactant stabilised systems, throat formation arises due to a combination of volume contraction caused by conversion of monomer to polymer and phase separation of the continuous phase into a polymer rich and a surfactant rich phase during the polymerisation. The surfactant rich phase, which may also contain some polymer and remaining monomers, is removed during the purification/drying step leaving pore throats behind. In contrast, during the polymerisation of Pickering emulsions the phase separation of the continuous phase into a polymer rich and a surfactant rich phase cannot occur. Instead, thin polymer films are formed in the area of contact points between neighbouring droplets, which in some cases rupture during the drying process. This leads to the partially open porous foam structure of poly-Pickering-HIPEs.

In the case of poly-Pickering-foams, the thin polymer films are relatively stable but as they are put under stress by the mechanical forces arising during the vacuum drying, some are forced to rupture as can be seen in FIG. 3. This gives rise to some degree of interconnectivity to neighbouring pores and allows for the complete removal of the trapped aqueous phase.

Of further interest was the fact that some polymer balls were found within some pores as seen in FIG. 4. This suggests that although most of the functionalised TNP were relatively hydrophobic, a minority were still hydrophilic enough to form an o/w emulsion within some of the droplets of the w/o emulsion. Following polymerisation and drying, these o/w emulsions in the w/o droplets became trapped polymer balls within the pores. This highlights an opportunity for polyHIPE foams to be made with a substructure within another substructure. Therefore, by utilising particles with different wettability, it is possible to formulate an emulsion template with one emulsion within another emulsion.

### EXAMPLE 3

### Use of Functionalised Particles to Stabilise HIPEs with Up to 85% Internal Volume Phase

Functionalised TNP with 4 wt. % oleic acid were prepared in a similar way to example 1. However, by repeating the purification step 3 times only more oleic acid was kept at the surface of the particles. These particles were used to prepare HIPEs. A stable emulsion with 85 vol. % internal phase (7) was achieved while preparation of a HIPE emulsion with 90 vol % internal phase led to phase separation. This suggests that the particle wettability of functionalised TNP with 4 wt. % oleic acid on the surface allows for the stabilisation of HIPEs with up to at least 85 vol. % internal phase.

Interestingly as can be seen in FIG. 5, the HIPEs 7 and 8 having 85 vol. % and 80 vol. % internal phase, respectively, experienced no sedimentation whilst in case of HIPE 9 containing 75 vol. % internal phase and MIPE 10 with 70 vol. % internal phase a minor amount of organic phase was expelled.

### EXAMPLE 4

### Use of Functionalised TNP to Stabilise HIPEs Containing Polyethylene Glycol Dimethacrylate (PEGDMA)

To investigate the adaptability of functionalised TNP particles to stabilise emulsions containing a more polar oil phase (i.e. different monomers), HIPE 11 having 80 vol. % internal phase and 20 vol. % organic phase consisting of 50:50 mixture of styrene and PEGDMA (by volume) was prepared using TNP functionalised with 4 wt. % oleic acid (same as in example 3). Thereby, PEGDMA acts also as crosslinker and replaced DVB (used in examples 2 and 3). This emulsion was extremely stable and experienced no sedimentation. After polymerisation, the resulting polyHIPE was very tough and difficult to break unlike the polyHIPEs made from DVB, which were brittle. SEM image shown in FIG. 6, showed that The PEGDMA based polyHIPE 11 possesses a closed cell porous network structure but otherwise similar structure if compared with the DVB based polyHIPEs 1-3.

### EXAMPLE 5

### Preparation of Functionalised Silica Nanoparticles with Oleic Acid

As with the titania particles, hydrophilic silica particles were surface treated with oleic acid and used as particle emulsifiers. 1 g of untreated silica particles were suspended in a 1:2 molar mixture of chloroform and oleic acid and stirred for 3 h to allow oleic acid to adsorb onto the silica surface before precipitating the particles from solution with methanol. Purification by partially removing the excess oleic acid involved a centrifugation step to retrieve the solid particles, re-suspension of the particles in chloroform using an ultrasound bath and precipitation using methanol, prior to drying at 120° C.

The functionalised silica particles, coated with 2-5 wt.-% oleic acid, were shown to be sufficiently hydrophobic to adsorb at the interface of w/o emulsions with ≧75% internal volume phase, to prevent droplet coalescence and phase inversion.

### EXAMPLE 6

### Preparation of Functional Silica Nanoparticles with an Acrylated Silane

In addition, silica particles were also surface treated with methacryloxypropyltri-methoxysilane (MPS). 1 g of untreated silica particles were suspended in 5 ml of MPS and 5 ml propanol and stirred for approximately 12 h. Purification required centrifugation and re-dispersion of the particles in methanol for 5-10 mins using an ultrasound bath. The purification process was repeated 3 times.

The functionalised silica particles, coated with 2-5 wt.-% MPS, were shown to be adequate to stabilise emulsions with ≧75% internal volume phase.

### EXAMPLE 7

### Use of Functionalised Silica Particles to Stabilise Pickering Emulsions and Formation of Polymer Foams Therefrom

1 wt.-% of the functionalised silica particles having an oleic acid content of 3.5 wt.-% was used to stabilise emulsion templates with ≧70% (by volume) internal aqueous phase and 0.27M CaCl₂.2H₂O as electrolyte. Only the emulsion template containing 70 vol.-% internal phase did undergo some immediate sedimentation before becoming as stable as the other Pickering-HIPEs. Stable emulsions were thus prepared from emulsion templates having 70-85 vol.-% internal phase emulsions (FIG. 7). An upper limit exists between 85-90 vol.-% internal phase when using 1 wt.-% of the functionalised silica particles as it was impossible to prepare a 90 vol.-% HIPE. Above this upper limit, phase separation of the emulsion occurred. The emulsions containing 70-85 vol.-% internal phase and styrene and PEGDMA (50:50 by volume) in the organic phase were polymerised to produce poly-Pickering foams.

In order to further prepare HIPEs with >85 vol.-% internal phase, the particle concentration of the functionalised silica particles was increased. Hence, it was possible to stabilise a 90 vol.-% emulsion using 2 wt.-% functionalised silica particles. It was also possible to prepare a 92 vol.-% emulsion using 4 wt.-% functionalised silica particles. These emulsions experienced no sedimentation but were viscous and extremely stable. Preparation of a HIPE with internal phase volume>92% under the preparation conditions or with further increase in the functionalised silica particle concentration was not successful. This was due to the increase in viscosity with increasing particle concentration. As the internal phase volume is already high (above 90 vol.-%), further increase in particle concentration makes the overall emulsion viscosity extremely high and it is no longer possible to add water to the emulsion. Rather, further increase in the internal phase results in a viscous emulsion surrounded by the intended aqueous phase.

It was thus concluded that an optimum particle concentration exists (4 wt.-% in the case of the functionalised silica particles) above which the maximum internal phase volume that can be achieved no longer increases but decreases. All emulsions contained styrene and PEGDMA (50:50 by volume) in the organic phase. It was possible to polymerise these emulsions into non brittle or chalky poly-Pickering foam. FIG. 8 is a representative image of a poly-Pickering foams synthesized from an emulsion having an internal phase volume≧90 vol.-%. The poly-Pickering foams have a cellular structure characteristic of close-celled polymer foams.

### EXAMPLE 8

### Use of MPS-Functionalised Silica Particles to Stabilise HIPEs Containing Styrene and PEGDMA

An 80 vol.-% HIPE containing styrene and PEGDMA (50:50 by volume) in the organic phase was stabilised against coalescence and phase inversion by 1 wt.-% functionalised silica particles wherein the functionalised silica particles comprise 3 wt % MPS. This RIPE containing styrene and PEGDMA was polymerised into a non brittle or chalky poly-Pickering foam. The resulting polymer-foam was observed to have a pore structure characteristic of poly-Pickering foams.

### EXAMPLE 9

### Inclusion of a Non-Stabilising Particles in a Pickering-HIPE

Pickering emulsions tend to be extremely stable due to the irreversible adsorption of particles at the interface between the 2 phases. It had been previously believed that it is impossible to stabilise HIPEs with particles since Pickering-type emulsions usually phase invert between 60-70 vol.-% internal phase. This work has now shown that it is possible to prepare Pickering-HIPEs with internal phase volumes up to 90 vol.-%. It has been further determined that the stability of the emulsion is not hindered when non-stabilising particles for example particles, for use as reinforcements, are added to the organic phase of an emulsion template.

An emulsion template containing 80 vol.-% internal phase was stabilised by 3 wt.-% functionalised titania particles and 5 wt.-% carbon particles (2-5 μm in diameter) included in the organic phase. The organic phase consisted of 50:50 (by volume) styrene and PEGDMA and the aqueous phase contained 0.27M CaCl₂.2H₂O as electrolyte. The prepared emulsion was viscous and extremely stable for weeks, showing no signs of sedimentation. It is important to note that the carbon particles when used solely to attempt to stabilise a RIPE gave an o/w emulsion. The polymerised foam had a pore structure characteristic of Poly-Pickering-HIPEs (FIG. 9).

FIG. 9 shows SEM images of a poly-Pickering-foam synthesized from an emulsion template having 80 vol.-% internal phase and stabilised by 3 wt.-% of oleic acid functionalised titania particles. Furthermore, the emulsion template contained 5 wt.-% carbon particles, which were added to the organic phase. a) Low magnification image showing the characteristic pore structure of poly-Pickering-foams and b) High magnification image showing a mixture of titania and carbon particles in the pores.

### EXAMPLE 10

### Using a Mixture of Surfactant and Particles to Stabilise HIPEs

Whilst the influence of the synergistic effect of a mixture of nanoparticles and surfactants in improving the emulsification and stability to coalescence of emulsions has been investigated previously (Eskander et al, Phys. Chem. Chem. Phys. 2007; 9, 6426-6434), research in synthesising polymer foams has concentrated on including particles in surfactant stabilised emulsions as reinforcements only (Haibach et al, Polymer 2006, 47(13), 4513-4519).

We have now stabilised an emulsion with a mixture of surfactant having the adequate HLB (hydrophilic-lipophilic balance) value to stabilise a w/o HIPEs and particles with the appropriate wettability to also stabilise w/o HIPEs. The purpose of this is to prepare polymer foams with multiple pore features.

An 80 vol.-% HIPE was stabilised by 1 wt.-% of the functionalised titania particles and 0.5 wt.-% Hypermer B246sf. The organic phase contained styrene, PEGDMA and the surfactant while the aqueous phase contained 0.27 M CaCl₂.2H₂O as electrolyte. The RIPE was viscous and stable. The polymerisation of this RIPE yielded a polymer foam having a cellular structure with 2 distinct features as shown in FIG. 10.

Thus, the use of a small amount of surfactant within a HIPE has been shown to lead to the production of a poly HIPE foam with large close-celled (50-200 μm) pores, which are typical for poly-Pickering-HIPEs, surrounded by smaller interconnected pores (5-20 μm), which are typical for common polyHIPEs prepared from surfactant stabilised RIPE templates. Polymer foams with this cellular structure could be used in applications where controlled release of an active ingredient, which can be enclosed in the closed pores during the preparation and polymerisation of the HIPE, is of importance. The active ingredient would be release via concentration gradient driven diffusion into the surrounding medium contained in the open porous structure.

The skilled person will appreciate that variations are possible without departing from the invention. Accordingly, the above description of embodiments and examples is made by way of example and it will be clear to the skilled person that other modifications can be made without departing from the spirit and scope of the invention.

1. A particle stabilised high internal phase emulsion comprising an internal phase which constitutes more than 75% of the total volume of the emulsion, a continuous phase and particles comprising a core and a coating, wherein the wettability of the core is modulated by the coating.

2. The emulsion of claim 1, wherein the core comprises a hydrophilic material and the coating imparts some hydrophobic character thereto or wherein the core comprises a hydrophobic molecule and the coating imparts some hydrophilic character thereto.

3. The emulsion of claim 1, wherein the core comprises a hydrophilic material.

4. The emulsion of claim 1, wherein the particles are formed of individual particles, particle aggregates or combinations thereof and wherein the particles or particle aggregates have an average diameter of up to 50 μm.

5. The emulsion of claim 1, wherein the internal phase of the emulsion constitutes up to 92 vol %.

6. The emulsion of claim 1, wherein the emulsion is an o/w emulsion or a w/o emulsion.

7. The emulsion of claim 1, wherein the core of the nanoparticles comprises a metal oxide or silica (SiO₂).

8. The emulsion of claim 7, wherein the metal oxide is titania (TiO₂).

9. The emulsion of claim 1, wherein the coating comprises at least one type of amphiphile.

10. The emulsion of claim 9, wherein the amphiphile is a saturated or unsaturated fatty acid.

11. The emulsion of claim 10, wherein the fatty acid is an unsaturated fatty acid.

12. The emulsion of claim 1, wherein the coating comprises an acryl-functionalised silane.

13. The emulsion of claim 12, wherein the acryl-functionalised silane is of formula (I): 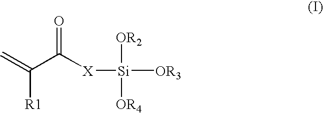
wherein R1 is hydrogen or C₁₋₆ alkyl;
each of R₂, R₃ and R₄ is independently C₁₋₆ alkyl; and
X is an alkyl chain optionally containing one or more —O-insertions.

14. The emulsion of claim 13, wherein the acryl-functionalised silane is methacryloxypropyltrimethoxysilane (MPS).

15. The emulsion of claim 1, wherein the coating constitutes 2 to 5 wt. % of the particles.

16. The emulsion of claim 1, wherein the particles are present in the emulsion at a weighting from 0.5 to 4 wt %, based on the continuous phase.

17. The emulsion of claim 1, wherein the emulsion is free of molecular emulsifier.

18. The emulsion of claim 1, wherein the emulsion comprises 1 wt % or less, based on the continuous phase, of a molecular emulsifier.

19. The emulsion of claim 1, wherein the continuous phase comprises at least one type of polymerisable monomer and optionally also at least one type of crosslinker.

20. The emulsion of claim 19, wherein the continuous phase additionally comprises a radical initiator and/or the internal phase comprises a radical initiator.

21. The emulsion of claim 1, wherein the emulsion additionally comprises non-functionalised particles.

22. A particle stabilised high internal phase emulsion comprising an internal phase, a continuous phase and particles comprising a core comprising a metal oxide and a coating comprising a fatty acid, wherein the wettability of the core is modulated by the coating.

23. (canceled)

24. A particle stabilised high internal phase emulsion comprising an internal phase, a continuous phase and particles comprising a core comprising silica and a coating comprising an acryl-functionalised silane, wherein the wettability of the core is modulated by the coating.

25. (canceled)

26. A method of producing a stabilised high internal phase emulsion comprising an internal phase and a continuous phase, wherein the internal phase constitutes more than 75% of the total volume of the emulsion, the method comprising suspending particles comprising a core and a coating, wherein the wettability of the core is modulated by the coating, within the continuous phase, mixing the internal phase with the continuous phase and agitating the mixture to produce a stabilised emulsion.

27. (canceled)

28. A porous polymer foam produced by polymerisation of the continuous phase of a stabilised high internal phase emulsion comprising an internal phase, a continuous phase comprising at least one type of polymerisable monomer and particles comprising a core and a coating, wherein the wettability of the core is modulated by the coating.

29. The foam of claim 28, wherein the porosity of the foam is at least 74%.

30. The foam of claim 28, wherein the foam is produced by polymerisation of an emulsion according to claim 1.

31. A method of producing a porous polymer foam wherein the method comprises providing a high internal phase emulsion as defined in claim 1, wherein the continuous phase comprises a polymerisable monomer and wherein the continuous phase and/or the internal phase comprises an initiator, and initiating polymerisation of the continuous phase.

32. A particle comprising an inorganic core and a coating, wherein the wettability of the inorganic core is modulated by the coating and wherein the coating comprises a fatty acid.

33. The particle of claim 32, wherein the inorganic core comprises silica or a metal oxide.

34. The particle of claim 32, wherein the fatty acid is an unsaturated fatty acid.

35. The particle of claim 32, wherein the fatty acid constitutes 2 to 5 wt % of the particle.

36. The particle of claim 32, wherein the particle has a diameter up to 50 μm.

37. An emulsion stabilised by a population of particles as defined in claim 32.

38. A method of producing a stabilised high internal phase emulsion comprising an internal phase and a continuous phase, the method comprising suspending particles according to claim 32 within the continuous phase, mixing the internal phase with the continuous phase and agitating the mixture to produce a stabilised emulsion.

39. A porous polymer foam produced by polymerisation of the continuous phase of an emulsion stabilised by particles according to claim 32.

40. A method of producing a porous polymer foam comprising providing an emulsion as defined in claim 37, wherein the continuous phase comprises a polymerisable monomer and wherein the continuous phase and/or the internal phase comprises an initiator, and initiating polymerisation of the continuous phase.

41. The emulsion of claim 3, wherein the core comprises a hydrophilic inorganic material.

42. The emulsion of claim 6, wherein the emulsion is a w/o emulsion.

43. The emulsion of claim 11, wherein the fatty acid is oleic acid.

44. The emulsion of claim 17, wherein the emulsion is free of surfactant.

45. The emulsion of claim 18, wherein the emulsion comprises 1 wt % or less, based on the continuous phase, of a surfactant.

46. The emulsion of claim 19, wherein the at least one type of polymerisable monomer is a styrene.

47. The emulsion of claim 19, wherein the at least one type of crosslinker is a divinylbenzene or polyethylene glycol dimethacrylate.

48. The emulsion of claim 20, wherein the radical initiator in the continuous phase is azobisisobutyronitrile (AIBN), 2,2′-azodi(2-methylbutyronitrile) or 2,2-di(4,4-di(tertbutylperoxy)cyclohexyl)propane.

49. The emulsion of claim 20, wherein the radical initiator in the internal phase is potassium persulfate.

50. The emulsion of claim 21, wherein the non-functionalised particles are carbon particles.

51. The emulsion of claim 22, wherein the metal oxide is titania (TiO₂).

52. The particle of claim 33, wherein the metal oxide is titania (TiO₂).

53. The particle of claim 34, wherein the fatty acid is oleic acid.

54. The emulsion of claim 37, wherein the emulsion is solely stabilised by a population of particles as defined in claim 32.

55. The porous polymer foam of claim 39, wherein the particles are nanoparticles.
